(19) United States
(12) Patent Application Publication
(10) Pub. No.: US 2019/0045270 A1
(43) Pub. Date: Feb. 7, 2019

(54) Intelligent Chatting on Digital Communication Network

(71) Applicant: Nitin Vats, Meerut, (IN)

(72) Inventor: Nitin Vats, Bengaluru (IN)

(73) Assignee: Nitin Vats, Bengaluru (IN)

(21) Appl. No.: 16/077,072

(22) PCT Filed: Feb. 10, 2017
(86) PCT No.: PCT/IB2017/050759

§ 371 Date: Aug. 10, 2018

(30) Foreign Application Priority Data
Feb. 10, 2016 (IN) 2583/DEL/2015

(51) Int. Cl. H04N 21/4788; H04L 12/58; H04M 3/56; G06T 19/20; G06T 15/02; G06K 9/00

(52) U.S. Cl. CPC H04N 21/4788; H04L 51/02; H04M 3/567; G06Q 50/01; G06T 15/02; G06K 9/00335; G06T 19/20

(57) ABSTRACT

A method for realistically interacting with user profile on a social media network, the social media network represents a network of various user profiles owned by their users wherein the user profiles are connected to each other with various level of relationship or non-connected, and the user profile comprising an image having face of the user, the method includes:
receiving a user request related to one of a user profile on the social media network, wherein the user request is for interacting with the user owning the user profile;
analysing the user request and providing a displaying information from at least one of a user profile initial information or a user profile activity information, or combination thereof, based on the user request,
   wherein the displaying information is a video or animation showing the face of the user,
   wherein the user profile initial information is an information provided while creating the user profile on the social media network or updated in the user profile,
   wherein the user profile activity information is an information derived from various activities carried out by the user through its user profile on the social media network, wherein the user profile activity information comprises at least one of relationship information between the user profiles, contents posted using the user profile, sharing of contents posted by other user profiles, annotating of contents posted by user profile, or combination thereof.

### FIELD OF THE INVENTION

The present invention relates to chatting with an image of a person on a social network or chatting application when user is not willing or not able to chat with that person.

### BACKGROUND

To communicate with anyone, a person should have been physically in front of you, so that a communication can be established. However, technology has advanced, and with invention of telephone, even you can have a communication when a person is far away. This communication is limited and voice-to-voice. To deal with this scenario, facilities like video conferencing and video chatting have come in light, where you can talk to a person in real time seeing face to face. However, for such face to face online chatting, firstly a person should be available to chat and also the person should know you to allow you to chat with himself.

Further, there are scenario, especially in case of celebrities, where the fans of celebrities, however the celebrity cannot talk to each of them, as he can be personally available to chat with a person, one at a time, and also he cannot be connected to each of his fans.

### OBJECT OF THE INVENTION

The object of the invention is to enable chatting when a person is offline, or not connected/known to another person in a social networking framework.

### SUMMARY OF THE INVENTION

The object of the invention is achieved by a method for realistically interacting with user profile on a social media network, the social media network represents a network of various user profiles owned by their users wherein the user profiles are connected to each other with various level of relationship or non-connected, and the user profile comprising an image having face of the user, the method includes:
receiving a user request related to one of a user profile on the social media network, wherein the user request is for interacting with the user owning the user profile;
analysing the user request and providing a displaying information from at least one of a user profile initial information or a user profile activity information, or combination thereof, based on the user request,

wherein the displaying information is a video or animation showing the face of the user,

wherein the user profile initial information is an information provided while creating the user profile on the social media network or updated in the user profile,

wherein the user profile activity information is an information derived from various activities carried out by the user through its user profile on the social media network, wherein the user profile activity information comprises at least one of relationship information between the user profiles, contents posted using the user profile, sharing of contents posted by other user profiles, annotating of contents posted by user profile, or combination thereof.

### BRIEF DESCRIPTION OF THE DRAWINGS

FIG. 1 illustrates a social network arrangement showing people connections over the social network.

FIG. 2 illustrates a form filled by the user who is offline or not connected to another user.

FIG. 3 illustrates a social network profile view, where the profile owner is communicating with realistic facial expression.

FIG. 4 illustrates a social network profile view, where the profile owner is communicating with realistic facial expression and body movement.

FIG. 5 illustrates a social network profile view, where communication of profile owner and another person is shown with their bodies interacting realistically with realistic face expressions.

FIG. 6 illustrates multiple chat windows operating at a particular time frame chatting with a single user.

FIG. 7A-C illustrates an example of communication between two profile owners about each other and other profile owners.

FIG. 8 illustrate the system diagram FIG. 9(a)-FIG. 9(b) illustrates the points showing facial feature on user face determined by processing the image using trained model to extract facial feature and segmentation of face parts for producing facial expressions while FIG. 9(c)-(f) shows different facial expression on user face produced by processing the user face.

FIG. 10(a)-(c) illustrates the user input of front and side image and face unwrap.

FIG. 11(a)-FIG. 11(b) illustrates the face generated in different angle and orientation by generated 3d model of user face.

### DETAILED DESCRIPTION

In one embodiment of the invention, the invention is implemented using following flow:
User create a profile in social networking site.
User input the image/video having a face.
User input the details about him/her, it may be social, professional or general information. User data involve answer to the question in terms of text/voice and user can associate the answer with emotion and movement command to give particular body movement or show expression while answering. User can use his/her video also while answering the question.
User can put different setting based on relationship to allow a particular user a limited information based of how that person is associated may be friend, not known or else, user can search for any user in social media system and ask for off line chat to know about the other user where the animated character of user will answer with facial and or body movement.

Online chat/call is also possible through one implementation of the invention

The Database include, Database for image processing, Database for Social Media environment, Database for human body model generation, Supporting Libraries.

Database for image processing includes Images, images of user having face, pre rigged images of user, body model of user, 3D model of user, videos/animations, Video/animation with predefined face location, image/video of animation of other characters, Images related to makeup, clothing and accessories, skeleton information related to user image/body model, image/video of environment, Trained model data which is generated by training with lots of faces/body and help in quickly extracting facial and body features.

Database for social media environment includes a Profile database, an activity module, a privacy module, and a relationship database.

The profile database is provided for keeping data related to each of the users. This data includes the information in terms of text and or voice and or video with or without expression and restricted permission. This further includes a training model which is generated by AI based learning for the user and it gradually update with the activities or other input from the user.

The activity module keep track of user activities/s on the social networking website related to interacting with news, entertainment media post, accessing information of friends and random users.

The privacy module allow to show restricted information about user to another user based on relationship and privacy setting, Relationship database store the link of other profile which are someway related to this user.

Datanase for human body model generation includes image/s or photograph/s of other human body part/s, Image/s or cloths/accessories, Image of background and images to producing shades and/or user information that includes information about human body information which is either provided by user as user input or generated by processing the user input comprises user image/s it can be used for next time when user is identify by some kind of login identity, then user will not require to generate the user body model again but can retrieve it from user data and try cloths on it and/or user data which includes generated user body after processing the user image that can be used next time and/or graphics data which includes user body part/s in graphics with rig which can be given animation which on processing with user face produces a user body model with cloths and it can show animation or body part movements wherein human body information comprises at least one of orientation of face of the person in the image of the person, orientation of body of the person in the image of the person, skin tone of the person, type of body part/s shown in the image of person, location and geometry of one or more body parts in image of the person, body/body parts shape, size of the person, weight of the person, height of the person, facial feature information, or nearby portion of facial features, or combination thereof.

The facial feature information comprises at least one of shape or location of at least face, eyes, chin, neck, lips, nose, or ear, or combination thereof.

Supporting Libraries includes one or more libraries described as follows; facial feature extraction trained model, skeleton information extraction model, tool to create animation in face/body part/s by trigger of Emotion & movement command, it may be smiley, text, symbol at client device, animation generation engine, skeleton animation generation engine, facial feature recognition engine, skeleton information extraction engine, text to voice conversion engine, voice learning engine from set of voice samples to convert voice of text in user, image morphing engine, lipsing & facial expression generation engine based on input voice, face orientation and expression finding engine form a given video, Facial orientation recognition and matching model, model for extracting facial features/lipsing from live video, tool to wrap or resize the makeup/clothing accessories images as per the face in the image, 3D face/body generation engine from images, libraries for image merging/blending, 3d model generation using front and side image of user face, rigging generation on user body model with or without cloths, Natural Language processing libraries, Artificial Intelligence based Learning engine.

In one embodiment; A method for realistically interacting with user profile on a social media network, the social media network represents a network of various user profiles owned by their users wherein the user profiles are connected to each other with various level of relationship or non-connected, and the user profile comprising an image having face of the user, the method comprising:
receiving a user request related to one of a user profile on the social media network, wherein the user request is for interacting with the user owning the user profile;
analysing the user request and providing a displaying information from at least one of a user profile initial information or a user profile activity information, or combination thereof, based on the user request,

wherein the displaying information is a video or animation showing the face of the user,

wherein the user profile initial information is an information provided while creating the user profile on the social media network or updated in the user profile,

wherein the user profile activity information is an information derived from various activities carried out by the user through its user profile on the social media network, wherein the user profile activity information comprises at least one of relationship information between the user profiles, contents posted using the user profile, sharing of contents posted by other user profiles, annotating of contents posted by user profile, or combination thereof.

In one embodiment, User can do chat with other profile holder when he/she is offline as the user model is AI based and generate the answer which shows users face lipsing, expression and/or body movement.

In yet another embodiment; during the chat with other user who is online/offline, the method is as follows;
A method for providing visual sequences using one or more images comprising:
receiving one or more person images of showing at least one face,
using a human body information to identify requirement of the other body part/s;
receiving at least one image or photograph of other human body part/s based on identified requirement;
processing the image/s of the person with the image/s of other human body part/s using the human body information to generate a body model of the person, the virtual model comprises face of the person,
receiving a message to be enacted by the person, wherein the message comprises at least a text or a emotional and movement command.
processing the message to extract or receive an audio data related to voice of the person, and a facial movement data related to expression to be carried on face of the person,
processing the body model, the audio data, and the facial movement data, and generating an animation of the body model of the person enacting the message,

Wherein emotional and movement command is a gui or multimedia based instruction to invoke the generation of facial expression/s and or body part/s movement.

In another embodiment of the invention, for generating a body model of a person wearing a cloth, an implementation of a method is as follows:
receiving an user input related to a person, wherein the user input comprises at least one image/photograph of the person, wherein at least one image of the person has face of the person;
using a human body information to identify requirement of the other body part/s;
receiving at least one image or photograph of other human body part/s based on identified requirement;
processing the image/s of the person with the image/s or photograph/s of other human body part/s using the human body information to generate a body model of the person, wherein the body model represent the person whose image/photograph is received as user input, and the body model comprises face of the person;
receiving an image of a cloth according to shape and size of the body model of the person;
Combining the body model of the person and the image of the cloth to show the body model of the human wearing the cloth;

wherein human body information comprises at least one of orientation of face of the person in the image of the person, orientation of body of the person in the image of the person, skin tone of the person, type of body part/s shown in the image of person, location and geometry of one or more body parts in image of the person, body/body parts shape, size of the person, weight of the person, height of the person, facial feature information, or nearby portion of facial features, or combination thereof,

wherein facial feature information comprises at least one of shape or location of at least face, eyes, chin, neck, lips, nose, or ear, or combination thereof.

The display system can be a wearable display or a non-wearable display or combination thereof.

The non-wearable display includes electronic visual displays such as LCD, LED, Plasma, OLED, video wall, box shaped display or display made of more than one electronic visual display or projector based or combination thereof.

The non-wearable display also includes a pepper's ghost based display with one or more faces made up of transparent inclined foil/screen illuminated by projector/s and/or electronic display/s wherein projector and/or electronic display showing different image of same virtual object rendered with different camera angle at different faces of pepper's ghost based display giving an illusion of a virtual object placed at one places whose different sides are viewable through different face of display based on pepper's ghost technology.

The wearable display includes head mounted display. The head mount display includes either one or two small displays with lenses and semi-transparent mirrors embedded in a helmet, eyeglasses or visor. The display units are miniaturised and may include CRT, LCDs, Liquid crystal on silicon (LCos), or OLED or multiple micro-displays to increase total resolution and field of view.

The head mounted display also includes a see through head mount display or optical head-mounted display with one or two display for one or both eyes which further comprises curved mirror based display or waveguide based display. See through head mount display are transparent or semi transparent display which shows the 3d model in front of users eye/s while user can also see the environment around him as well.

The head mounted display also includes video see through head mount display or immersive head mount display for fully 3D viewing by feeding rendering of same view with two slightly different perspective to make a complete 3D viewing. Immersive head mount display shows output in virtual environment which is immersive.

In one embodiment, the output moves relative to movement of a wearer of the head-mount display in such a way to give to give an illusion of output to be intact at one place while other sides of 3D model are available to be viewed and interacted by the wearer of head mount display by moving around intact 3D model.

The display system also includes a volumetric display to display the output and interaction in three physical dimensions space, create 3-D imagery via the emission, scattering, beam splitter or through illumination from well-defined regions in three dimensional space, the volumetric 3-D displays are either auto stereoscopic or auto multiscopic to create 3-D imagery visible to an unaided eye, the volumetric display further comprises holographic and highly multiview displays displaying the 3D model by projecting a three-dimensional light field within a volume.

In one embodiment for generating a body model of a person wearing a cloth, a methodology of the invention includes:
receiving an user input related to a person, wherein the user input comprises at least one image/photograph of the person, wherein at least one image of the person has face of the person;
using a human body information to identify requirement of the other body part/s;
receiving at least one image or photograph of other human body part/s based on identified requirement;
processing the image/s of the person with the image/s or photograph/s of other human body part/s using the human body information to generate a body model of the person, wherein the body model represent the person whose image/photograph is received as user input, and the body model comprises face of the person;
receiving an image of a cloth according to shape and size of the body model of the person;
Combining the body model of the person and the image of the cloth to show the body model of the human wearing the cloth;

wherein human body information comprises at least one of orientation of face of the person in the image of the person, orientation of body of the person in the image of the person, skin tone of the person, type of body part/s shown in the image of person, location and geometry of one or more body parts in image of the person, body/body parts shape, size of the person, weight of the person, height of the person, facial feature information, or nearby portion of facial features, or combination thereof,

wherein facial feature information comprises at least one of shape or location of at least face, eyes, chin, neck, lips, nose, or ear, or combination thereof.

In one another embodiment, for providing visual sequences using one or more images, a methodology of implementation of the invention includes:
receiving one or more person images of showing at least one face,
using a human body information to identify requirement of the other body part/s;
receiving at least one image or photograph of other human body part/s based on identified requirement;
processing the image/s of the person with the image/s of other human body part/s using the human body information to generate a body model of the person, the virtual model comprises face of the person,
receiving a message to be enacted by the person, wherein the message comprises at least a text or a emotion and movement command,
processing the message to extract or receive an audio data related to voice of the person, and a facial movement data related to expression to be carried on face of the person,
processing the body model, the audio data, and the facial movement data, and generating an animation of the body model of the person enacting the message.

In one embodiment, the aspects of the invention are implemented by a method to add yourself with intelligent chat user need to create a profile page and need to fill a data form in following steps:

Step 1: Opening form for the user to be filled out.

Step 2: Answer some or all questions which are presented in the form by providing text and/or voice and optionally choosing smiley for facial expression and body movement which user want to show while answering the question on chat. Optionally user can mark answers as public available to all or private for people connected to him on the communication network.

Step 3: If user want to share some information which is not related to any of the questions in the form, then adding a new question to the form and adding an answer to the question by providing text and/or voice and optionally choosing smiley for facial expression and body movement which user want to show while answering the question on chat. Optionally user can mark answers as public available to all or private for people connected to him on the communication network.

Step 4: Optionally user can also add answers related to daily updates on the communication network without adding any appropriate question, by providing text and/or voice and optionally choosing smiley for facial expression and body movement which user want to show while answering the question on chat. Optionally user can mark answers as public available to all or private for people connected to him on the communication network.

Step 5: Saving the form

The form can be opened again for filling or editing the answers and steps 1 to 5 will be repeated for filling and editing the form.

In one embodiment, the aspects of invention for chatting with an offline or unconnected user are implemented by a method using following steps:
Opening up a chat window of a profile holder showing an image and text box, and a text writing area for writing a text and/or a voice entering medium;
The online user types a text in the text writing area and/or enters his voice in the chat window;
The text and/or the voice entered by the online user is processed to be matched with a suitable answer from the form data. If no similar answer is found in the form data then the search is made in general profile data. If the question is about a profile holder which is not connected to the person to whom chatting is being done then answer will be searched in general profile data. If the question is related to particular profile holder who is connected to the person to whom chatting is being done then answer will be searched from the form data of that person.
processing the answer with lipsing and or facial expression and/or body movement using database and different engines to generate an output
displaying the output video as answer to the question on chat window
   Here user can just send text/voice on chat window and profile holder's image can be pre-processed on server or may be process in real time on server or may be process on the computer on the user computer. Generating the bone structure (rigging and skinning) for moving the body parts of character body image once for repetitive usage of the above method steps. Once the bone structure is generated, they are saved for future usage.

There Exist Various Methods for Face detection which are based on either of skin tone based segmentation, Feature based detection, template matching or Neural Network based detection.

For example; Seminal work of Viola Jones based on Haar features is generally used in many face detection libraries for quick face detection.

Haar Feature is define as follows:

Lets consider a term “Integral image” which is similar to the summed area table and contains entries for each location such that entry on (x, y) location is the sum of all pixel values above and left to this location.

$$ii ( x , y ) = {\sum }_{{x}^{′} \leq x , {y}^{′} \leq y} i ( {x}^{′} , {y}^{′} )$$

where ii(x, y) is the integral image and i(x, y) is original image.

Integral image allows the features (in this method Haar-like-features are used) used by this detector to be computed very quickly. The sum of the pixels which lie within the white rectangles are subtracted from the sum of pixels in the grey rectangles. Using integral image, only six array reference are needed to compute two rectangle features, eight array references for three rectangle features etc which let features to be computed in constant time O(1).

After extracting Feature, The learning algorithm is used to select a small number of critical visual features from a very large set of potential features Such Methods use only few important features from large set of features after learning result using Learning algorithm and cascading of classifiers make this real time face detection system.

In realistic scenario users upload pics which are in different orientation and angels. For such cases, Neural Network based face detection algorithms can be used which leverage the high capacity of convolution networks for classification and feature extraction to learn a single classifier for detecting faces from multiple views and positions. To obtain the final face detector, a Sliding window approach is used because it has less complexity and is independent of extra modules such as selective search. First, the fully connected layers are converted into convolution layers by reshaping layer parameters. This made it possible to efficiently run the Convolution Neural Network on images of any size and obtain a heat-map of the face classifier.

Once we have a detected the face, the next is to find the location of different facial features (e.g. corners of the eyes, eyebrows, and the mouth, the tip of the nose etc.) accurately.

For an Example; to precisely estimate the position of facial landmarks in a computationally efficient way, one can use dlib library to extract facial features or landmark points.

Some methods are based on utilizing a cascade of regressors. The cascade of regressors can be defined as follows:

Let xᵢ∈R² be the x, y-coordinates of the ith facial landmark in an image I. Then the vector S=(x₁^{T},x₂^{T}, . . . ,xₚ^{T})^{T}∈R^{2p} denotes the coordinates of all the p facial landmarks in I. The vector S represent the shape. Each regressor, in the cascade predicts an update vector from the image. On Learning each regressor in the cascade, feature points estimated at different levels of the cascade are initialized with the mean shape which is centered at the output of a basic Viola & Jones face detector.

Thereafter, extracted feature points can be used in expression analysis and generation of geometry-driven photorealistic facial expression synthesis.

For applying makeup on lips, one need to identify lips region in face. For this, after getting facial feature points, a smooth Bezier curve is obtained which captures almost whole lip region in input image. Also, Lip detection can be achieved by color based segmentation methods based on color information. The facial feature detection methods give some facial feature points (x,y coordinates) in all cases invariant to different light, illumination, race and face pose. These points cover lip region. However, drawing smart Bezier curves will capture the whole region of lips using facial feature points.

Generally Various Human skin tone lies in a particular range of hue and saturation in HSB color space (Hue, Saturation, and Brightness). In most scenario only the brightness part varies for different skin tone, in a range of hue and saturation. Under certain lighting conditions, color is orientation invariant. The studies show that in spite of different skin color of the different race, age, sex, this difference is mainly concentrated in brightness and different people's skin color distributions have clustering in the color space removed brightness. In spite of RGB color space, HSV or YCbCr color space is used for skin color based segmentation.

Merging, Blending or Stitching of images are techniques of combining two or more images in such a way that joining area or seam do not appear in the processed image. A very basic technique of image blending is linear blending to combine or merge two images into one image: A parameter X is used in the joining area (or overlapping region) of both images. Output pixel value in the joining region:

P_{Joining}_{_}_{Region}(i,j)=(1−X)*P_{First}_{_}_{Image}(i,j)+X*P_{Second}_{_}_{Image}(i,j).

Where 0<X<1, remaining region of images are remain unchanged.

Other Techniques such as ‘Poisson Image Editing (Perez et al.)’, ‘Seamless Stitching of Images Based on a Haar Wavelet 2d Integration Method (Ioana et al.)’ or ‘Alignment and Mosaicing of Non-Overlapping Images (Yair et al.)’ can be used for blending.

For achieving life-like facial animation various techniques are being used now-a day's which includes performance-driven techniques, statistical appearance models or others. To implement performance-driven techniques approach, feature points are located on the face of an uploaded image provided by user and the displacement of these feature points over time is used either to update the vertex locations of a polygonal model, or are mapped to an underlying muscle-based model.

Given the feature point positions of a facial expression, to compute the corresponding expression image, one possibility would be to use some mechanism such as physical simulation to figure out the geometric deformations for each point on the face, and then render the resulting surface.

Given a set of example expressions, one can generate photorealistic facial expressions through convex combination. Let Eᵢ=(GₚIᵢ), i=0, . . . , m, be the example expressions where Gᵢ represents the geometry and Ii is the texture image. We assume that all the texture images Iᵢ are pixel aligned. Let H(E₀, E₁, . . . , Eₘ) be the set of all possible convex combinations of these examples. Then

$$H ( {E}_{0} , {E}_{1} , … , {E}_{m} ) = \{ ( {\sum }_{i = 0}^{m} {c}_{i} {G}_{i} , {\sum }_{i = 0}^{m} {c}_{i} {I}_{i} ) \vert {\sum }_{i = 0}^{m} {c}_{i} = 1 , {c}_{i} \geq 0 , i = 0 , … , m \}$$

While the statistical appearance models are generated by combining a model of shape variation with a model of texture variation. The texture is defined as the pattern of intensities or colors across an image patch. To build a model, it requires a training set of annotated images where corresponding points have been marked on each example. The main techniques used to apply facial animation to a character includes morph targets animation, bone driven animation, texture-based animation (2D or 3D), and physiological models.

User will be able to chat with other users when they are offline on not willing to chat with that particular user. It is a computer program which conducts a conversation via auditory or textual methods. Such programs are often designed to convincingly simulate how a human would behave as a conversational partner, thereby passing the Turing test.

This program may use either sophisticated natural language processing systems, or some simpler systems which scan for keywords within the input, and pull a reply with the most matching keywords, or the most similar wording pattern, from a database. There are two main types of programs, one functions based on a set of rules, and the other more advanced version uses artificial intelligence. The programs based on rules, tend to be limited in functionality, and are as smart as they are programmed to be. On the other end, programs that use artificial intelligence, understands language, not just commands, and continuously gets smarter as it learns from conversations it has with people. Deep Learning techniques can be used for both retrieval-based and generative models, but research seems to be moving into the generative direction. Deep Learning architectures like Sequence to Sequence are uniquely suited for generating text. Few example includes Retrieval-based models which use a repository of predefined responses and some kind of heuristic to pick an appropriate response based on the input and context. The heuristic could be as simple as a rule-based expression match, or as complex as an ensemble of Machine Learning classifiers. These systems don't generate any new text, they just pick a response from a fixed set while other such as Generative models don't rely on pre-defined responses. They generate new responses from scratch. Generative models are typically based on Machine Translation techniques, but instead of translating from one language to another, we “translate” from an input to an output (response).

User can use image or 3D character to represent himself or herself. This should be able to express different facial poster, neck movement and body movement. It is always easy to give body moment using skeleton animation.

Skeletal animation is a technique in computer animation in which a character (or other articulated object) is represented in two parts: a surface representation used to draw the character (called skin or mesh) and a hierarchical set of interconnected bones (called the skeleton or rig) used to animate the mess.

Rigging is making our characters able to move. The process of rigging is we take that digital sculpture, and we start building the skeleton, the muscles, and we attach the skin to the character, and we also create a set of animation controls, which our animators use to push and pull the body around. While Setting up a character to walk and talk is the last stage before the process of character animation can begin. This stage is called ‘rigging and skinning’ and is the underlying system that drives the movement of a character to bring it to life. Rigging is the process to setting up a controllable skeleton for the character that is intended for animation. Depending on the subject matter, every rig is unique and so is the corresponding set of controls.

Skinning is the process of attaching the 3D model (skin) to the rigged skeleton so that the 3D model can be manipulated by the controls of the rig. In case of 2D character, 2D mesh is generated on which the character image is linked and the bones are attached to different points giving it, degree of freedom to move the character's body part/s. Animate a character can be produced with predefined controllers in rigging to move, scale and rotate in different angels and directions for realistic feel as to show a real character in computer graphics.

The feature extraction model recognizes a face, shoulders, elbows, hands, a waist, knees, and feet from the user shape, it extracts feature points with respect to the face, both shoulders, a chest, both elbows, both hands, the waist, both knees, and both feet. Accordingly, the user skeleton may be generated by connecting the feature points extracted from the user shape.

In general, the skeleton may be generated by recognizing many markers attached on a lot of portions of a user and extracting the recognized markers as feature points. However, in the exemplary embodiment, the feature points may be extracted by processing the user shape within the user image by an image processing method, and thus the skeleton may easily be generated. The extractor, extracts feature points with respect to eyes, a nose, an upper lip center, a lower lip center, both ends of lips, and a center of a contact portion between the upper and lower lips. Accordingly, a user face skeleton may be generated by connecting the feature points extracted from the user face. If the user face skeleton extracted from the user image is animated to generate animated user image/virtual model.

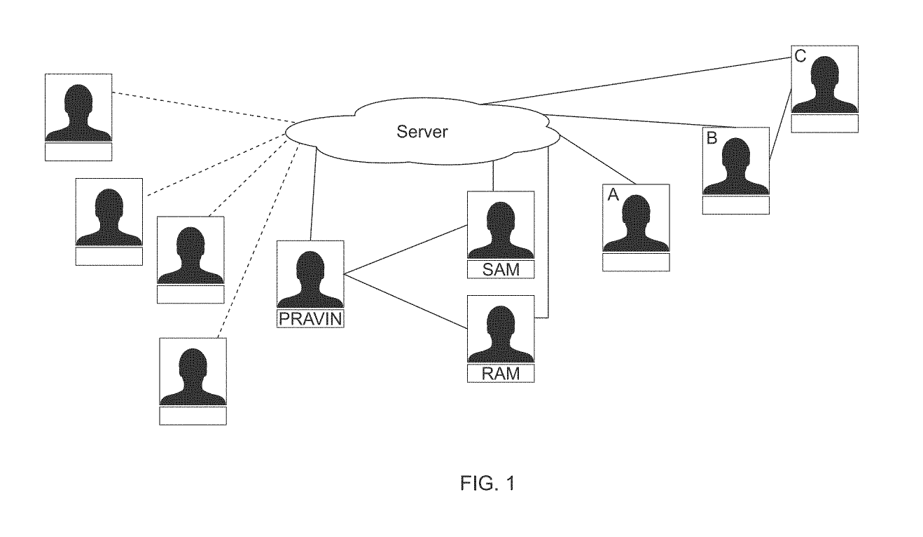

FIG. 1 illustrates a social network arrangement showing people connections over the social network. On a server, multiple persons make their profile on a social network application. Inter-relationship between various profiles is shown in the figure. The figure shows profile “Ram” is connected to “Pravin”, and profile “Sam” is connected “Pravin”, however, there the profile Ram and Sam are not connected. Communication between “Ram” and “Pravin”, and “Sam” and “Pravin” is possible through an online chat application provided over the social network. However, such communication is not possible between “Ram” and “Sam”, as they are not connected to each other on the social network. Also, “Ram” and “Sam” can have only very limited public information about each other.

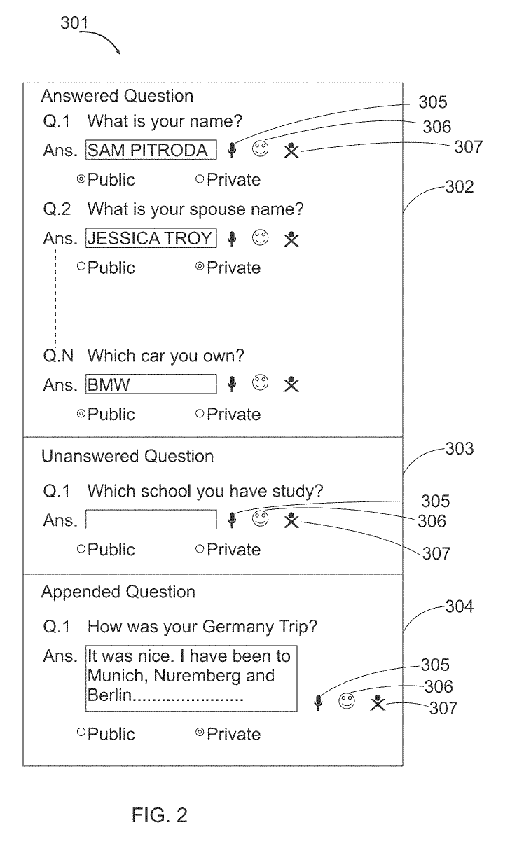

FIG. 2 illustrates a form 301 filled by the user who is offline or not connected to another user. The form 301 is divided into three parts 302, 303, and 304. First part 302 relates to the questions answered by the user and the corresponding answers, second part 303 relates to the questions which are unanswered by the user, and third part 304 relates to appended questions which are automatically added into the form based on an online environment related to the user. Also, each answers are categorized to be public or private. The answers belonging to the public category is available to all people, while the answers which are categorized to be the private category are available only to a selected few.

Also, each answers has an audio, and/or a facial expression, and/or body movement associated to it. The audio, facial expression and the body movement is either recorded by the user himself or generated by the system itself. For recording of the audio an audio recording button 305 is provided. The body movement and facial expression are recorded by using a video recording button 307. In case, a user wanted to use a different facial expression than the one recorded by video recording, it can choose pre-determined facial expressions, may be by choosing a smiley by using a facial expression button 306.

For generation of the audio by the system, the system may use any other pre-recorded voice of the user available from another source to give a realistic voice from the user himself. In case pre-recorded voice is not available than the user takes up any random voice to produce the audio. For generation of the body movement, the system may use any pre-determined body movements associated to a particular type of answer and map the pre-determined body movement onto body of the user.

The user when makes its presence to a system, for example a social network, he/she is asked to fill a variety of questions through the form 301. The questions answered by him/her are kept in part one 302 of the form, while the questions unanswered by him are kept in part two 303. The unanswered questions in second part 303 are not available to anyone and such questions if raised, will result into a common answer referring to unavailability of the answers. The unanswered questions in second part 303 are available for the user to be filled again for the answers at his or her own convenience.

It is a known fact that each person uses different words to question for a similar answer. The system identifies all those arrangement of words and index it to a particular answer, so that all such questions are answered and answered with the same answer. For example, the questions, “Where do you live?”, “Where do you placed?”, “Location?”, “Which geographical area you belongs to?” even though different words are used to make the same question referring to “Living place”, they have same answer. Thus, even though, an answered is filled to a question, same answer is indexed to similar questions, which have same meaning.

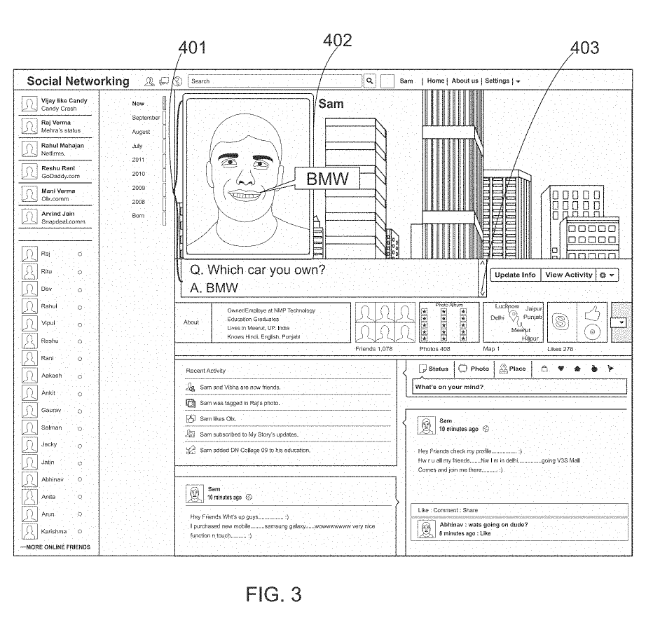

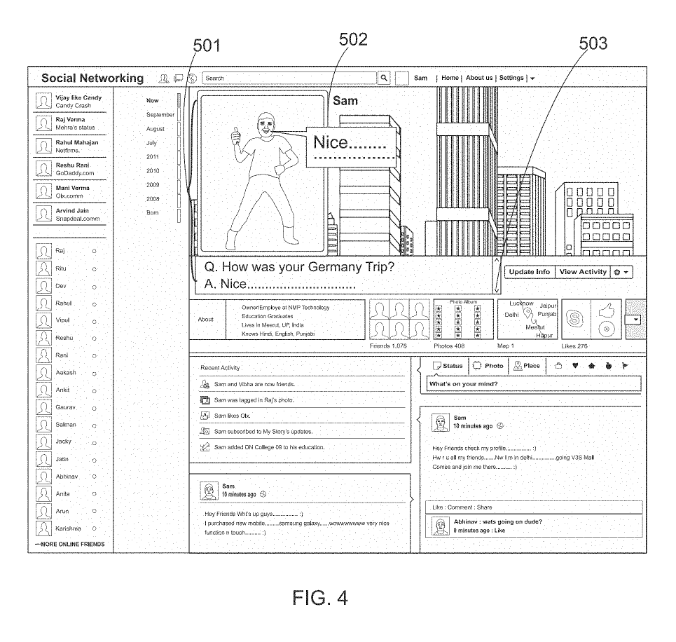

FIG. 3 illustrates a social network profile view, where the profile owner is communicating with realistic facial expression even being offline or not connected. This communication is based on the form 301 filled by the profile owner or appended in part 304 of the form 301 by the system. A chat window 401 at the receiver's end is divided into two parts 402 and 403. An image of the profile owner who filled the question and answers in the list 301 appears in the part 402, while part 403 has an area where receiver is allowed to write. In part 403, another person seeking to communicate with the profile owner writes “Which car do you own?” This is one of the questions provided in part one 302 of the form 301, where the questions are answered by the profile owner. The profile owner's image in the part 402 speaks out “BMW” with realistic facial expressions of being “pride” and audio already recorded by the profile owner in the form 301. FIG. 4 illustrates a social network profile view, where the profile owner is communicating with realistic facial expression and body movement. Here also a similar chat window 501 is provided as in FIG. 3, divided into two parts 502 and 503. A full body image of the profile owner who filled out the answers to the questions provided in the form 301, is shown in part 502. While in part 503, another person seeking to communicate with the profile owner writes “How was your Germany trip?” This is a question from part three 304 of the form 301, where the answer was appended by the system itself by taking in consideration various social networking posts the profile owner has made in past few days. The profile owner's video appears in part 503 doing a body movement along with facial expressions and audio generated by the system. One of the frame of the video is shown in this figure where the profile owner's one hand is shown raised to shoulder length and thumb and adjacent finger touching each other at ends to make a round. Also a speak out is shown to refer to an amended answer by the system with facial expression of being “happy”.

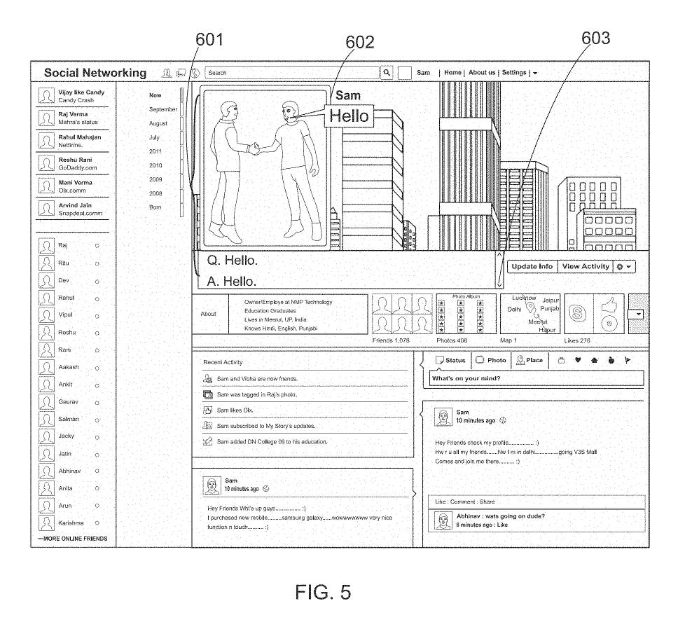

FIG. 5 illustrates a social network profile view, where communication of profile owner and another person is shown with their bodies interacting realistically with realistic face expressions. Here also a similar chat window 601 is provided as in FIG. 3, divided into two parts 602 and 603. A full body image of the profile owner who filled out the answers to the questions provided in the form 301, is shown in part 602 along with full body image of another person communicating with the profile owner. Here another person is looking to have a virtual experience of greeting the profile owner, as if another person is greeting the profile owner in real life. Such scenario are common when a fan is conversing with a celebrity virtually, or loved one talking to each other virtually. In this figure, a frame of a video of greeting by the profile owner and another user is shown. In the frame, the another user is shown typing in part 603 “hello”, where in part 602 the two full bodies are shown in a handshake moment, where the two bodies are standing opposite to each other sideways in “handshake” pose.

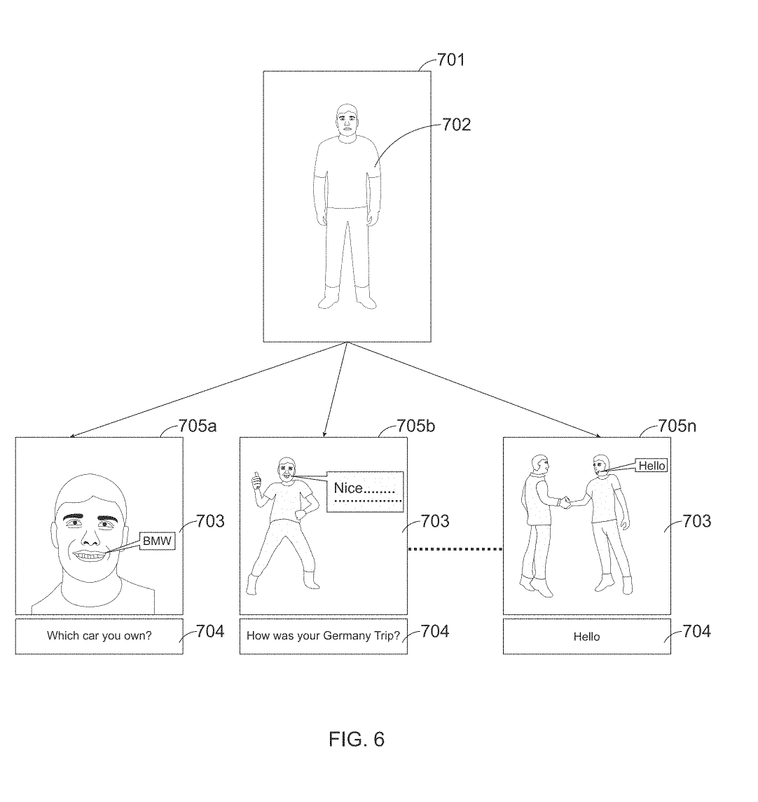

FIG. 6 illustrates multiple chat windows operating at a particular time frame where many persons chatting to a single person. An image 701 having a character 702 is shown along with multiple chat windows 705a, 705b, . . . , 705n each having two parts 703 and 704. In the first part 703, one person has typed a question to the character 702 shown in the image 701. And, in the second part 704, a video of the character 702 is displayed answering the question with a realistic facial expressions and optionally along with body movements. For answering the questions, the system uses questions and answers of the form 301. In chat window 705a, in the first part 703, a question “Which car do you own?” is typed and in the second part 704, a video frame of the character 702 is shown speaking out “BMW” with realistic facial expressions of being “pride”. In chat window 705b, in the first part 703, a question “How was your Germany trip?” is typed and in the second part 704, a video frame of the character 702 is shown where the character's one hand is raised to shoulder length and thumb and adjacent finger touching each other at ends to make a round, and also a speak out is shown to refer to an amended answer by the system with facial expression of being “happy”. In chat window 705n, in the first part 703, a text “Hello” is typed and in the second part 704, a video frame of the character 702 along with another character representing the person who has typed “hello” is shown in a “handshake” posture, where the character 702 is speaking out “Hello” with realistic facial expressions.

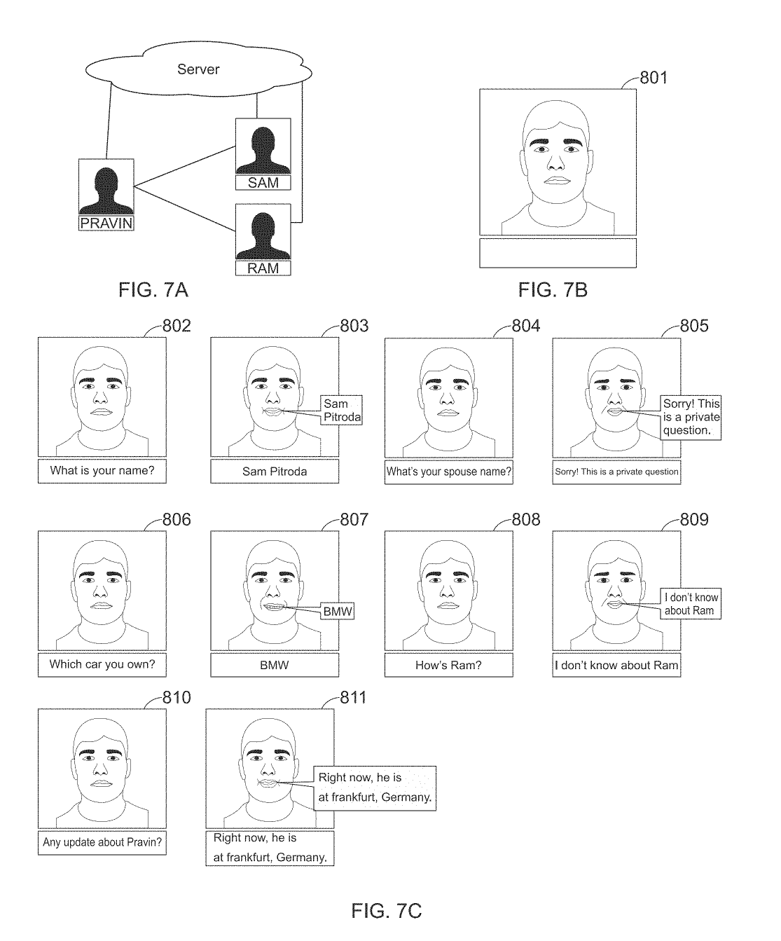

FIG. 7A-C illustrates an example of communication between two profile owners about each other and other profile owners. FIG. 7A shows a part of communication network, where PRAVIN is connected to RAM and SAM, while RAM and SAM are not connected to each other. FIG. 7B shows a chat window at client device of one of the user from the communication network, having a text entering area and image of SAM. The user is going to start communication with SAM. FIG. 7C shows various instances of communication between the user and SAM, about SAM and other user's connected to SAM. Whenever the user writes questions in the text area, he receives answers as a processed video using image of SAM and answers in the form 301 disclosed in FIG. 2. At one instance, the user types question, “What is your name?”. Same is shown through a chat window frame 802. Answer to this question is generated as a video. One of the frame 803 of the video is shown where the image 801 of SAM is speaking out “SAM” with realistic expressions.

At another instance, the user types question, “What is your spouse name?” Same is shown through a chat window frame 804. Answer to this question is generated as a video. One of the frame 805 of the video is shown where the image 801 of SAM is speaking out “Sorry! This is a private question” with realistic expressions of being helpless.

At another instance, the user types question, “Which car do you own?” Same is shown through a chat window frame 806. Answer to this question is generated as a video. One of the frame 807 of the video is shown where the image 801 of SAM is speaking out “BMW” with realistic expressions of being pride.

At another instance, the user types question, “How is RAM”. Same is shown through a chat window frame 808. SAM is not connected to RAM over the communication network, so form data of RAM is inaccessible to SAM. Answer to this question is generated as a video. One of the frame 809 of the video is shown where the image 801 of SAM is speaking out “I don't know RAM” with realistic expressions of being helpless.

At another instance, the user types question, “How is PRAVIN”. Same is shown through a chat window frame 810. SAM is connected to PRAVIN over the communication network, so form data of PRAVIN is accessible to SAM. Answer to this question is generated as a video. One of the frame 811 of the video is shown where the image 801 of SAM is speaking out “Right now he is at Frankfurt, Germany” with realistic expressions.

The above embodiments have applications in any scenario where the persons communicating are not physically present for a face to face communications, like online chatting, social networking profile, etc.

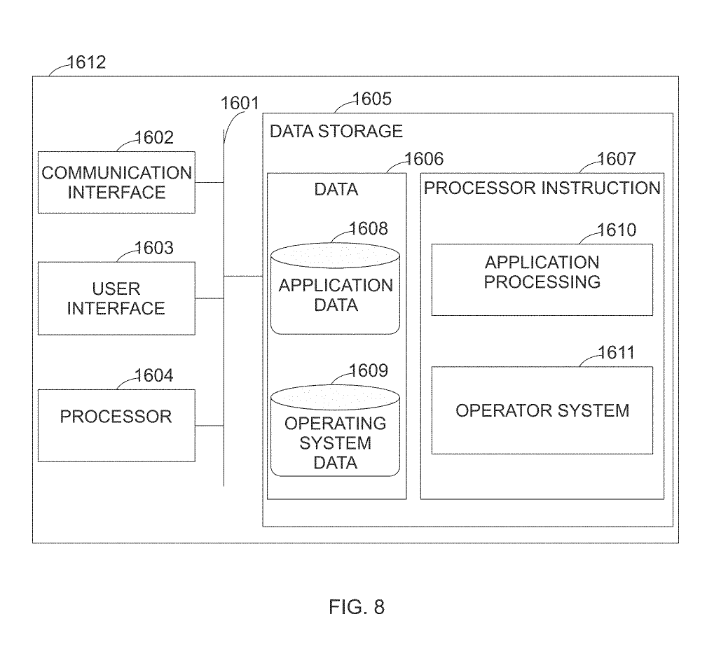

FIG. 8 is a simplified block diagram showing some of the components of an example client device 1612. By way of example and without limitation, client device is a any device, including but not limited to portable or desktop computers, smart phones and electronic tablets, television systems, game consoles, kiosks and the like equipped with one or more wireless or wired communication interfaces. 1612 can include memory interface, data processor(s), image processor(s) or central processing unit(s), and peripherals interface. Memory interface, processor(s) or peripherals interface can be separate components or can be integrated in one or more integrated circuits. The various components described above can be coupled by one or more communication buses or signal lines.

Sensors, devices, and subsystems can be coupled to peripherals interface to facilitate multiple functionalities. For example, motion sensor, light sensor, and proximity sensor can be coupled to peripherals interface to facilitate orientation, lighting, and proximity functions of the device.

As shown in FIG. 8, client device 1612 may include a communication interface 1602, a user interface 1603, and a processor 1604, and data storage 1605, all of which may be communicatively linked together by a system bus, network, or other connection mechanism.

Communication interface 1602 functions to allow client device 1612 to communicate with other devices, access networks, and/or transport networks. Thus, communication interface 1602 may facilitate circuit-switched and/or packet-switched communication, such as POTS communication and/or IP or other packetized communication. For instance, communication interface 1602 may include a chipset and antenna arranged for wireless communication with a radio access network or an access point. Also, communication interface 1602 may take the form of a wireline interface, such as an Ethernet, Token Ring, or USB port. Communication interface 1602 may also take the form of a wireless interface, such as a Wifi, BLUETOOTH®, global positioning system (GPS), or wide-area wireless interface (e.g., WiMAX or LTE). However, other forms of physical layer interfaces and other types of standard or proprietary communication protocols may be used over communication interface 102 Furthermore, communication interface 1502 may comprise multiple physical communication interfaces (e.g., a Wifi interface, a BLUETOOTH® interface, and a wide-area wireless interface).

Wired communication subsystems can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The device may include wireless communication subsystems designed to operate over a global system for mobile communications (GSM) network, a GPRS network, an enhanced data GSM environment (EDGE) network, 802.x communication networks (e.g., WiFi, WiMax, or 3 G networks), code division multiple access (CDMA) networks, and a Bluetooth™ network. Communication subsystems may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

User interface 1603 may function to allow client device 1612 to interact with a human or non-human user, such as to receive input from a user and to provide output to the user. Thus, user interface 1603 may include input components such as a keypad, keyboard, touch-sensitive or presence-sensitive panel, computer mouse, joystick, microphone, still camera and/or video camera, gesture sensor, tactile based input device. The input component also includes a pointing device such as mouse; a gesture guided input or eye movement or voice command captured by a sensor, an infrared-based sensor; a touch input; input received by changing the positioning/orientation of accelerometer and/or gyroscope and/or magnetometer attached with wearable display or with mobile devices or with moving display; or a command to a virtual assistant.

Audio subsystem can be coupled to a speaker and one or more microphones to facilitate voice-enabled functions, such as voice recognition, voice replication, digital recording, and telephony functions.

User interface 1603 may also be configured to generate audible output(s), via a speaker, speaker jack, audio output port, audio output device, earphones, and/or other similar devices, now known or later developed. In some embodiments, user interface 1603 may include software, circuitry, or another form of logic that can transmit data to and/or receive data from external user input/output devices. Additionally or alternatively, client device 112 may support remote access from another device, via communication interface 1602 or via another physical interface.

I/O subsystem can include touch controller and/or other input controller(s). Touch controller can be coupled to a touch surface. Touch surface and touch controller can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface. In one implementation, touch surface can display virtual or soft buttons and a virtual keyboard, which can be used as an input/output device by the user.

Other input controller(s) can be coupled to other input/control devices, such as one or more buttons, rocker switches, thumb-wheel, infrared port, USB port, and/or a pointer device such as a stylus. The one or more buttons (not shown) can include an up/down button for volume control of speaker and/or microphone.

The computer system can include clients and servers. A client and server are generally remote from each other and typically interact through a network. The relationship of client and server arises by virtue of computer programs running on the respective computers and having a client-server relationship to each other.

One or more features or steps of the embodiments can be implemented using an Application Programming Interface (API). An API can define on or more parameters that are passed between a calling application and other software code (e.g., an operating system, library routine, function) that provides a service, that provides data, or that performs an operation or a computation.

Processor 1604 may comprise one or more general-purpose processors (e.g., microprocessors) and/or one or more special purpose processors (e.g., DSPs, CPUs, FPUs, network processors, or ASICs).

Data storage 1605 may include one or more volatile and/or non-volatile storage components, such as magnetic, optical, flash, or organic storage, and may be integrated in whole or in part with processor 1604. Data storage 1605 may include removable and/or non-removable components.

In general, processor 1604 may be capable of executing program instructions 1607 (e.g., compiled or non-compiled program logic and/or machine code) stored in data storage 1505 to carry out the various functions described herein. Therefore, data storage 1605 may include a non-transitory computer-readable medium, having stored thereon program instructions that, upon execution by client device 1612, cause client device 1612 to carry out any of the methods, processes, or functions disclosed in this specification and/or the accompanying drawings. The execution of program instructions 1607 by processor 1604 may result in processor 1604 using data 1606.

By way of example, program instructions 1607 may include an operating system 1611 (e.g., an operating system kernel, device driver(s), and/or other modules) and one or more application programs 1610 installed on client device 1612 Similarly, data 1606 may include operating system data 1609 and application data 1608. Operating system data 1609 may be accessible primarily to operating system 1611, and application data 1608 may be accessible primarily to one or more of application programs 1610. Application data 1608 may be arranged in a file system that is visible to or hidden from a user of client device 1612.

FIG. 9(a)-FIG. 9(b) illustrates the points showing facial feature on user face determined by processing the image using trained model to extract facial feature and segmentation of face parts for producing facial expressions while FIG. 9(c)-(f) shows different facial expression on user face produced by processing the user face.

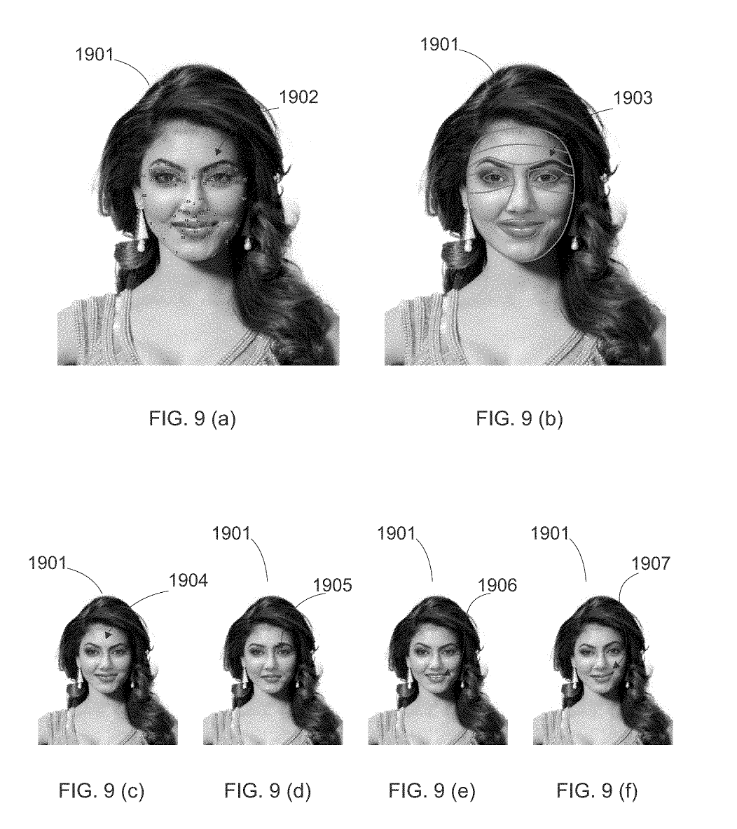

FIG. 10(a)-FIG (b) illustrates the user input of front and side image of face and FIG. 10 (c) show the face unwrap produced by logic of making 3d model of face using front and side image of face.

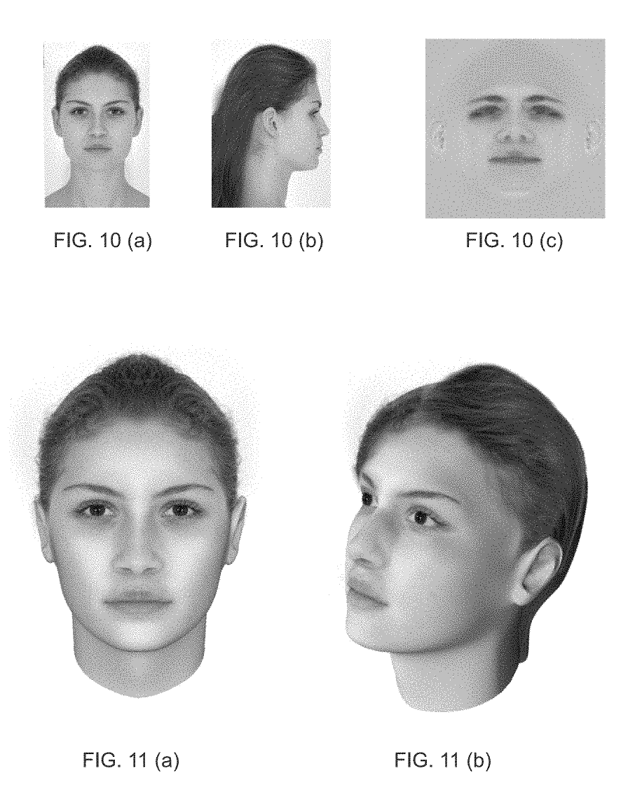

FIG. 11(a)-FIG. 11(b) illustrates the face generated in different angle and orientation by generated 3d model of user face. Once the 3D model of face is generated then it can be rendered to produce face in any angle or orientation to produce user body model in any angle or orientation using other person's body part/s image in same or similar orientation and/or angle

1. A method for realistically interacting with user profile on a social media network, the social media network represents a network of various user profiles owned by their users wherein the user profiles are connected to each other with various level of relationship or non-connected, and the user profile comprising an image having face of the user, the method comprising:
receiving a user request related to one of a user profile on the social media network, wherein the user request is for interacting with the user owning the user profile;
analysing the user request and providing a displaying information from at least one of a user profile initial information or a user profile activity information, or combination thereof, based on the user request,
wherein the displaying information is a video or animation showing the face of the user,
wherein the user profile initial information is an information provided while creating the user profile on the social media network or updated in the user profile,
wherein the user profile activity information is an information derived from various activities carried out by the user through its user profile on the social media network, wherein the user profile activity information comprises at least one of relationship information between the user profiles, contents posted using the user profile, sharing of contents posted by other user profiles, annotating of contents posted by user profile, or combination thereof.

2. The method according to the claim 1, wherein the user profile initial information comprises various piece of information, and at least one piece of information is provided by the user in audio format.

3. The method according to the claim 1, wherein the user profile initial information comprises various piece of information, and at least one piece of information is mapped with a particular facial expression and/or body part/s movement.

4. The method according to the claim 1, wherein the user profile initial information comprises various piece of information, and each piece of information is mapped to a privacy level selected from a set of privacy level.

5. The method according to the claim 1, wherein the image comprises at least one more body part except face of the user, and the user profile initial information comprises various piece of information, and at least one piece of information is linked to a body movement, wherein the body movement is movement of at least one of the body part other than face as provided in the image of the user.

6. The method according to the claim 1, wherein the user request is a chat request made by user of one user profile to at least one of another user profiles, the method comprises receiving conversation input comprising at least text or audio, or combination thereof, from either of the user profile, and processing the conversation input and the image of the user profile to provide the display output showing the user with at least voice, lipsing, facial expression, or body movement, or combination thereof.

7. The method according to the claim 6 comprising:
processing image of each of the user profile in conversation based on the chat request and generating an environment image showing face of each of the user profile,
processing the conversation input and the environment image, and generating the display output showing the users in conversation with at least one of the user with at least voice, lipsing, facial expression, or body movement, or combination thereof.

8. The method according to the claim 1, wherein the displaying information is a video or animation showing the user in two dimension or three dimension.

9. The method according to the claim 1, comprising:
extracting at least one of facial features and body features from the image of the user profile;
processing the extracted features to enact the display information.

10. The method according to claim 1, comprising:
receiving a wearing input related to a body part of the user in the image of the user profile onto which a fashion accessory is to be worn;
processing the wearing input and identifying body part/s of the user onto which the fashion accessory is to be worn;
receiving an image/video of the accessory according to the wearing input;
processing the identified body part/s the user and the image/video of the accessory and generating a view showing the user wearing the fashion accessory.

11. The method according to the claim 1, comprising:
using a human body information to identify requirement of the other body part/s;
receiving at least one image or photograph of other human body part/s based on identified requirement;
processing the image of the user with the image/s or photograph/s of other human body part/s using the human body information to generate a body model of the user, wherein the body model represent the person whose image/photograph is received as user input, and the body model comprises face of the person,
wherein human body information comprises at least one of orientation of face of the user in the image of the user, orientation of body of the user in the image of the user, skin tone of the user, type of body part/s shown in the image of user, location and geometry of one or more body parts in image of the user, body/body parts shape, size of the user, weight of the user, height of the user, facial feature information, or nearby portion of facial features, or combination thereof,
wherein facial feature information comprises at least one of shape or location of at least face, eyes, chin, neck, lips, nose, or ear, or combination thereof.

12. The method according to the claim 11, comprising:
receiving an image of a cloth according to shape and size of the body model of the user;
combining the body model of the user and the image of the cloth to show the body model of the user wearing the cloth.

13. The method according to the claim 1, comprising:
receiving a chat request made by an user with at least one another user,
establishing a chat environment between the users based on the chat request,
receiving at least one image representative of at least one of the users, wherein the image comprising at least one face,
receiving a message from at least one of the users in the chat environment, wherein the message comprises at least one of a text, a voice and a smiley, or combination thereof,
processing the message to extract or receive an audio data related to voice of the user, and a facial movement data related to expression to be carried on face of the user,
processing the image/s, the audio data, and the facial movement data, and generating an animation of the user enacting the message in the chat environment.

14. The method according to claim 13, wherein the message from a first computing device is received at a second computing device, and processing the image/s, the audio data, and the facial movement data, and generating the animation of the user enacting the message in the chat environment onto the second computing device.

15. The method according to the claim 13, comprising:
receiving at least one image representative of more than one users in the chat environment,
processing the image/s, and generating a scene image showing the users in the chat environment,
processing the scene image, the audio data, and the facial movement data, and generating an animation of the persons enacting the message in the chat environment.

16. The method according to the claim 13, comprising:
receiving a wearing input related to a body part of the user in the chat environment onto which a fashion accessory is to be worn;
processing the wearing input and identifying body part/s of the user onto which the fashion accessory is to be worn;
receiving an image/video of the accessory according to the wearing input;
processing the identified body part/s the user and the image/video of the accessory and generating a view showing the user wearing the fashion accessory in the chat environment.

17. The method according to the claim 13, comprising:
receiving an image of a cloth according to shape and size of the user;
processing the image of the user and the image of the cloth to show the user wearing the cloth in the chat environment.

18. The method according to the claim 1, comprising:
receiving a target image showing a face of another person or animal,
processing the user image and the target image to generate a morphed image showing the face from the target image on the user's body from the image of the user.

19. The method according to the claim 1, comprising:
receiving a message from at least one of the users of the social media network, wherein the message comprises at least one of a text, a voice and a smiley, or combination thereof.
processing the message to extract or receive an audio data related to voice of the user, and a facial movement data related to expression to be carried on face of the user,
processing the image of the user, the audio data, and the facial movement data, and generating an animation of the user enacting the message.

20. The method according to the claim 19, wherein each user profile has a time line where at least one category of a user allowed through privacy setting to post the message, the comprising:
receiving a post request by the category of the user allowed to post the message;
processing the post request, and displaying the message onto the time line.
